(19) United States
(12) Patent Application Publication
(10) Pub. No.: US 2025/0277522 A1
(43) Pub. Date: Sep. 4, 2025

(54) DAMPING RING ASSEMBLY

(71) Applicant: Caterpillar Inc., Peoria, IL (US)

(72) Inventors: Benjamin J. KUNZEMAN, Dunlap, IL (US); Brad S. SALISBURY, Metamora, IL (US); Akilan APPAVU, Ashok Nagar (IN); Edward R. SMITH, Peoria, IL (US); Donovan S. CLARKE, East Peoria, IL (US)

(73) Assignee: Caterpillar Inc., Peoria, IL (US)

(21) Appl. No.: 18/593,657

(22) Filed: Mar. 1, 2024

(51) Int. Cl. F16H 55/30; B62D 55/096

(52) U.S. Cl. CPC F16H 55/30; B62D 55/0963; F16H 2055/306

(57) ABSTRACT

A damping ring assembly may include a plurality of damping members, each of the damping members including an arc length, a radial thickness, a plurality of recesses located on an end surface and a retention groove on an outer surface of the damping members. A damping ring assembly may also include a plurality of brackets for attaching the plurality of damping members to a circumferential surface of a drive sprocket, the plurality of brackets each including a radially inner leg, a radially outer leg, and a joining central portion that connects the radially inner leg and the radially outer leg.

### TECHNICAL FIELD

The present disclosure relates generally to a track drive assembly and continuous ground-engaging track for a mobile industrial vehicle, and more particularly, to a sprocket damping assembly for a drive sprocket and the ground-engaging track.

### BACKGROUND

Mobile industrial machines, such as track-type tractors, are used in a variety of applications and offer the advantage of a rugged build and performance in challenging ground conditions on a work site. An undercarriage of a track-type industrial machine may include an endless track made of a number of connected links, a drive sprocket driven by a power source of the industrial machine (e.g., an internal combustion engine or electric motor) that meshes with the links to drive the track, and a number of idler wheels that distribute the weight of the work machine along the track.

Track-type industrial machines may generate loud noises during operation, which may be objectionable when operating in highly populated areas. Environmental regulations, both in the United States and in other countries, are increasingly being directed to suppressing noise generated by the operation of construction equipment. One potential source of operating noise that can also be a source of wear on the industrial machine is the metal-to-metal impact occurring between the teeth of the drive sprocket and bushings of the track links during the meshing between the teeth and the links.

A sprocket damping assembly for a sprocket wheel is described in U.S. Pat. No. 11,535,319 B2, issued Dec. 27, 2022 (“the ‘319 Patent”). The sprocket damping system described in the ‘319 Patent includes a damping ring that is disposed on the sprocket wheel, and the damping ring includes an integrally formed retention groove for retaining a retention device. While the sprocket damping assembly described in the ‘319 Patent may be helpful in some circumstances, the sprocket damping assembly may be subject to movement after being secured to the sprocket wheel.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a damping ring assembly for a drive sprocket of a mobile industrial machine, the damping member including a plurality of damping members, with each of the damping members including an arc length, a radial thickness, a plurality of recesses located on an end surface and a retention groove on an outer surface of the damping members. The damping ring assembly also includes a plurality of brackets, the plurality of brackets each including a radially inner leg, a radially outer leg, and a joining central portion that connects the radially inner leg and the radially outer leg.

In another aspect, a drive sprocket damping assembly for a mobile industrial machine, the drive sprocket damping assembly including a plurality of damping members, each of the damping members including an arc length, a radial thickness, and a plurality of recesses spaced along an end surface. Each of the plurality of recesses may include a threaded insert configured to receive a threaded fastener for securing individual damping member to a sprocket drum. Further, the damping assembly includes a plurality of brackets configured to be coupled to an end face of the sprocket drum at a first bracket end and to one of the threaded inserts in the end surface of the individual damping member at a second bracket end. The plurality of damping members together form a circumferential shape when installed onto a surface of a drive sprocket.

In yet another aspect, a method of assembling a damping ring assembly to a drive sprocket, the damping ring assembly including a plurality of damping members with a plurality of recesses located on an end surface and a plurality of brackets. The method includes fastening a radially inner leg of each of the plurality of brackets to the drive sprocket and fastening a radially outer leg of each of the plurality of brackets to one of the plurality of recesses located in the end surface of the damping members. The step of fastening the radially inner legs and radially outer legs is repeated until an entire outer circumference of a surface portion of the drive sprocket is covered with a damping member.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a side view of a track-type mobile industrial machine including a sprocket damping assembly, according to aspects of the disclosure.

FIG. 2 is an enlarged, isometric view of the sprocket damping assembly on the drive sprocket of FIG. 1.

FIG. 3 is a cross-sectional view taken through line 3-3 of FIG. 2 depicting a portion of the drive sprocket and sprocket damping assembly.

FIG. 4 is a cross-sectional view taken through line 4-4 of FIG. 3 depicting a portion of the drive sprocket and sprocket damping assembly.

FIG. 5A an isometric, inner view of a section of a damping ring of the sprocket damping assembly of FIG. 3

FIG. 5B is an isometric outer view of a section of the damping ring of the sprocket damping assembly of FIG. 3.

FIG. 5C is an isometric view of a damping ring bracket of the sprocket damping assembly of FIG. 3.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

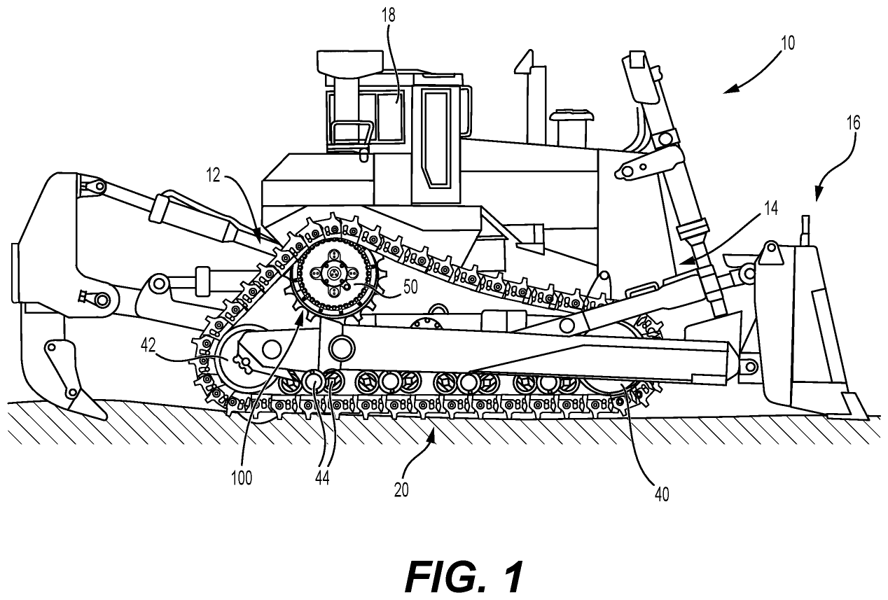

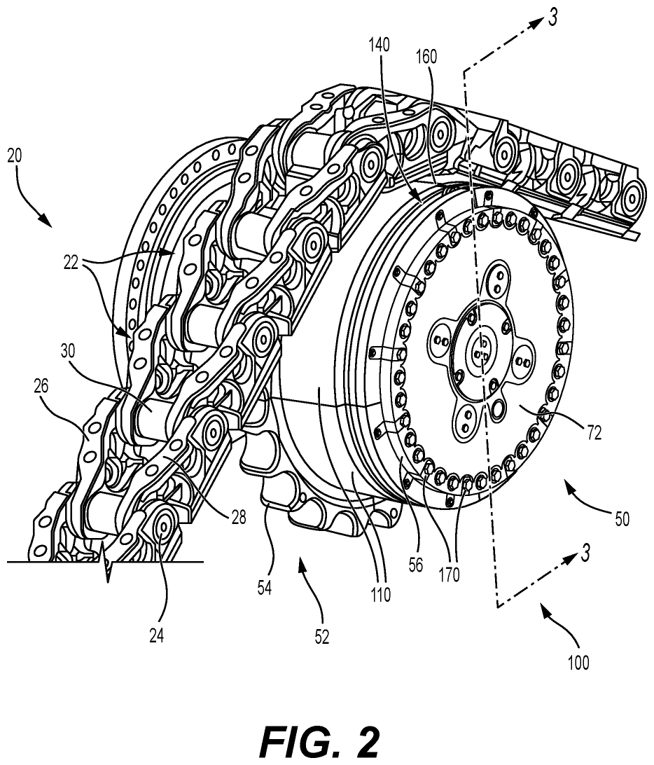

FIGS. 1 and 2 depict a mobile industrial machine 10 comprising a track drive assembly 12 with a power source (not shown), a continuous ground-engaging track 20, at least one drive sprocket 50, and a sprocket damping assembly 100. The sprocket damping assembly 100 (best shown in FIG. 2) includes a plurality of damping ring members 110 attached to the drive sprocket 50 via a plurality of retaining brackets 170 and axial fasteners, according to aspects of the present disclosure. While the mobile industrial machine 10 of FIG. 1 is shown in the context of a heavy-duty track-type tractor, the sprocket damping assembly 100 of the present disclosure is not thereby limited, and other types of track-type work machines, such as excavators, track loaders, and other similar machines, are within the scope of the present disclosure. As shown in FIG. 1, track-type tractor 10 further includes a tractor frame 14 mounted on top of the track drive assembly 12, an implement system 16 attached to a portion of the tractor frame 14, and an operator cabin 18.

The track drive assembly 12 includes the pair of endless or continuous ground-engaging tracks 20, a plurality of idler wheels 40-44, and the at least one drive sprocket 50. The ground-engaging tracks 20 (one of which is visible in FIG. 1) are mounted onto the drive sprocket 50 and idler wheels 40-44 of the track drive assembly 12. Note that while only a single drive sprocket 50, a single front idler 40, a single rear idler 42, and multiple rollers 44 have been shown in FIG. 1, track drive assembly 12 may include different configurations. For example, FIG. 1 illustrates a high-drive configuration, where the drive sprocket 50 is positioned vertically higher than a front idler wheel 44 and a rear idler wheel 46; however, alternative configurations, such as a low-drive configuration, are possible. The sprocket damping assemblies 100, as discussed, may be implemented on the drive sprocket 50, however, the same or similar damping assemblies 100 could be included additionally or alternatively on the front or rear idler wheels 40, 42, and/or the idle rollers 44 of the track-type tractor 10.

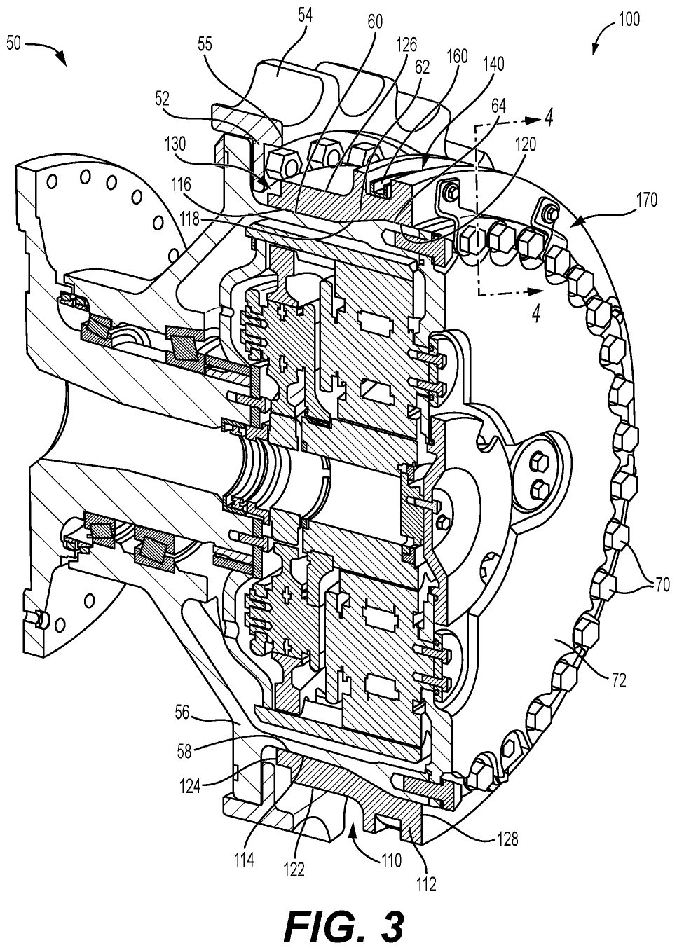

FIG. 2 illustrates the drive sprocket 50 with the mounted sprocket damping assembly 100 and a portion of the ground-engaging track 20 in further detail. The drive sprocket 50 is a sprocket wheel that includes a sprocket drum 56 with an external circumferential surface 58 (located beneath a plurality of damping ring members 110 and labeled in FIG. 3), a plurality of sprocket gear ring segments 52 mounted onto the sprocket drum 56, and an end cap 72 secured to an axially outer end face of the sprocket drum 56. Alternatively, the drive sprocket 50 may include a unitary sprocket gear ring rather than ring segments 52. FIG. 2 also depicts a portion of the ground-engaging track 20 (track shoes omitted), and includes a plurality of track links 22 connected via link pins 24. Each of the track links 22 includes a first link rail 26 and a second link rail 28 spaced apart by a link bushing 30. Additional or alternative track components may be used in the ground-engaging track 20. The spacing between the link rails 26, 28 allows sprocket teeth 54 of the sprocket gear ring segments 52 to rotate between the link rails 26, 28 as the track links 22 travel relative to the drive sprocket 50. The track links 22 and the circumferential spacing of the sprocket teeth 54 are sized so that adjacent link bushings 30 may be received into grooves defined between adjacent sprocket teeth 54 to drive the ground-engaging track 20. While the link rails 26, 28 are spaced from the circumferential surface 58 of the sprocket drum 56 as the track links 22 travel about the drive sprocket 50, the link bushings 30 contact the sprocket teeth 54 and are received within grooves between the adjacent sprocket teeth 54.

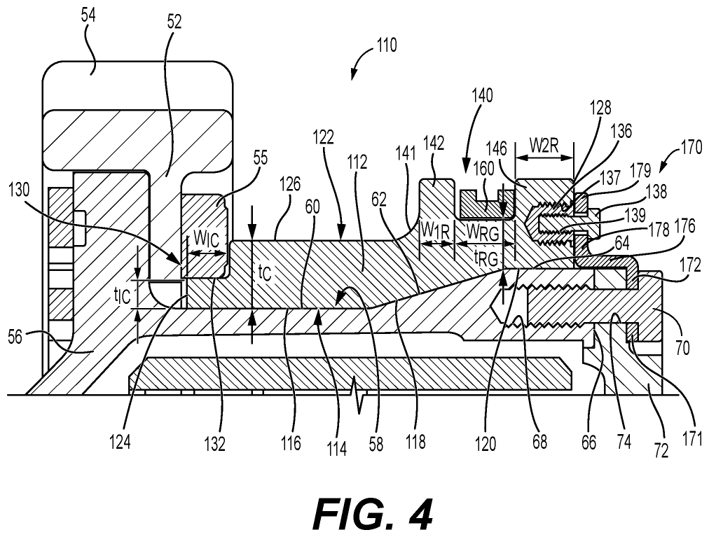

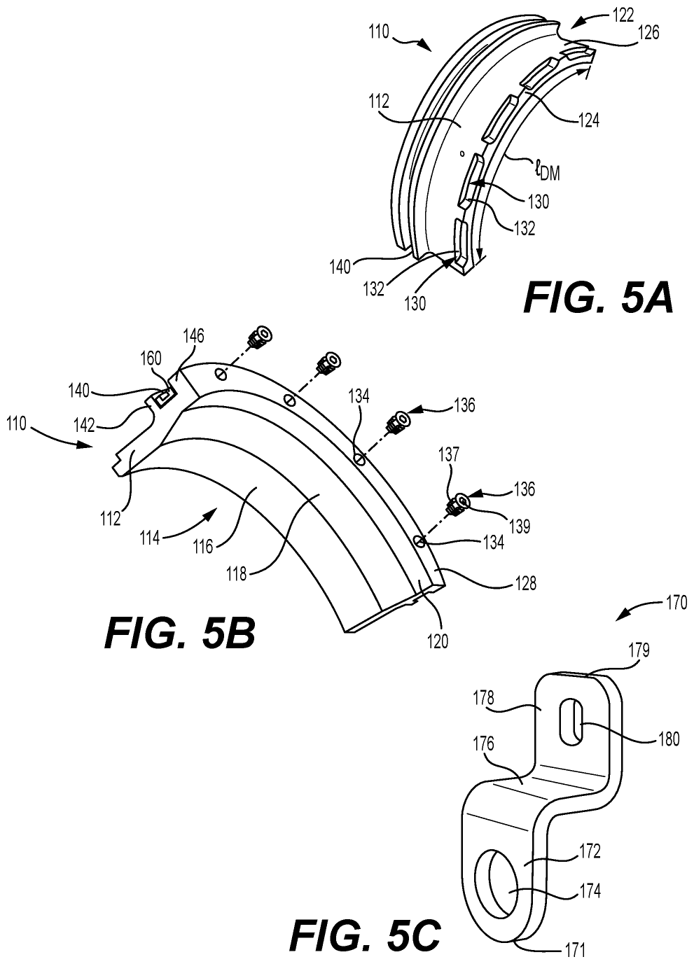

The sprocket damping assembly 100 is installed onto the circumferential surface 58 of the sprocket drum 56, as shown in FIGS. 2-4. The sprocket damping assembly 100 includes the plurality of damping ring members 110, an annular retention groove 140 located on a radially external surface 122 of each damping ring member 110, and a member retention system that includes a retention device 160 and a plurality of retaining brackets 170. As shown in FIG. 3, each damping ring member 110 includes a main body 112 with a radially internal surface 114 and the radially external surface 122, with the radial surfaces 114 and 122 defining a general radial thickness of the main body 112 (also shown in FIG. 4). The damping ring members 110 may be fabricated from an elastomeric or resilient material, such as rubber, polyurethane, other polymers and elastomers and the like. The damping ring members 110 comprise an arcuate shape (shown in FIGS. 5A & 5B) and are assembled along the circumferential surface 58 of the sprocket drum 56. For example, the sprocket damping assembly 100 of FIG. 2 includes four arcuate damping ring members 110 (three of which are visible in FIG. 2); however, the sprocket damping assembly 100 may include additional or less damping ring members 110. For example, in an alternative embodiment, the sprocket damping assembly 100 may be made of a single unitary damping ring.

When assembled or installed, the damping ring members 110 together comprise a generally annular shape that is complimentary to the shape of the circumferential surface 58 of the sprocket drum 56. For example, in FIGS. 3 and 4, the circumferential surface 58 of the sprocket drum 56 is shown to include a first constant-diameter surface 60 located proximal to the sprocket gear ring segments 52, a tapered surface 62, and a second constant-diameter surface 64 that is distal to the sprocket gear ring segments 52 and proximal to the sprocket drum end cap 72. The tapered surface 62 slopes at a tapered angle ranging from 0 to 90 degrees, as measured relative to the first constant-diameter surface 60 or the second constant-diameter surface 64 from an exterior perspective. The first and second constant-diameter surfaces 60, 64 may be substantially parallel to each other. It should be noted that, while FIGS. 3 and 4 illustrate the use of a circumferential surface 58 with a pair of constant-diameter sections 60, 64 and a tapered section 62, the circumferential surface 58 may alternatively include a substantially uniform or constant diameter across the length of the sprocket drum 56, or a diameter that otherwise varies along the length of the sprocket drum 56.

The radially internal surface 114 of the damping ring member 110, as shown in FIGS. 3 and 4, may have a conforming or matching shape with the various portions of the circumferential surface 58 of the sprocket drum 56. Thus, the radially internal surface 114 of the damping ring member 110 may include a first radially inner constant-diameter section 116 that corresponds to the constant-diameter surface 60 of the sprocket drum 56, a tapered section 118 of the damping ring member 110 that corresponds to the tapered surface 62, and a second radially inner constant-diameter section 120 that corresponds to the second constant-diameter surface 64. With this corresponding or matching shape between the circumferential surface 58 of the sprocket drum 56 and the radially internal surface 114 of an individual damping ring member 110, the radially internal surface 114 of the damping ring member 110 conforms to and generally aligns with the circumferential surface 58 of the sprocket drum 56. Further, the tapered surface 62 and tapered section 118 taper radially inwardly away from a second axially outer end surface 128 (shown in FIG. 4), thereby restricting the damping ring members 110 from moving axially away from the sprocket gear ring segments 52. As used in this disclosure, the phrase constant-diameter or tapered means a substantially or approximately constant diameter or tapered, respectively.

Referring to FIG. 4, the radially external surface 122 of the damping ring member 110 may include a third radially outer constant-diameter section 126 and the retention groove 140. The third radially outer constant-diameter section 126, which generally corresponds to and is parallel with the first radially inner constant-diameter section 116 of the radially internal surface 114 of the damping ring member 110, includes a generally constant radial thickness t_{c} of the damping ring member 110 which may be based on a plurality of factors, including the assembled height of the drive sprocket 50, the relative lifespan of the drive sprocket 50, optimized compression calculations for reducing potential gaps between the drive sprocket 50 and the link rails 26, 28, and other similar data points. The third radially outer constant-diameter section 126 is bounded between a first axially inner end surface 124 of the damping ring member 110 and a corner 141 that radially extends into a first retention wall 142 of the retention groove 140. The corner 141 may be rounded or filleted (shown in FIG. 4) or may be a 90 degree angle (not shown) relative to the radially external surface 122 and the first retention wall 142.

The retention groove 140, as shown in FIG. 4, is bounded on either side by the first retention wall 142 and a second retention wall 146, which may include the same height as, a height that is less than, or a height that is greater than the third radially outer constant-diameter section 126. For example, in FIG. 4, the heights of the of the first and second retention walls 142, 146 are shown to be radially elevated above the third radially outer constant-diameter section 126 of the external surface 122. The second retention wall 146 opposes the first retention wall 142 and terminates in the second axially outer end face 128 of the damping ring member 110. The annular retention groove 140 includes an axial width w_{RG} that is less than a general width of the individual damping ring members 110 (shown in FIG. 4). Each of the first and the second retention walls 142, 146 include an axial width, w_{1R} and w_{2R} respectively. In FIG. 4, the axial width w_{2R} of the second retention wall 146 is shown to be greater than the axial width w_{1R} of the first retention wall 142, such that the axial width of the second retention wall w_{2R} is capable of retaining a plurality of bracket threaded inserts 136 within the second retention wall 146; however, the axial widths, w_{1R} and w_{2R}, may vary based on the specific geometry and overall dimensions of the drive sprocket 50. As depicted in FIG. 4, the retention groove 140 is recessed radially inward from an exterior perspective, toward the radially internal surface 114 of the damping ring member 110, and has a variable radial thickness t_{RG} (based on tapering section 118) that is less than the constant radial thickness of the damping ring member t_{c}. In an alternative embodiment, the retention groove radial thickness t_{RG} may be substantially equal to or greater than the constant radial thickness t_{c} of the third radially outer constant-diameter section 126. The retention groove radial thickness t_{RG} is sized such that a retention device 160 is wholly retained within the retention groove 140.

In FIGS. 4 and 5A, each of the damping ring member 110 include an arc length l_{DM} (FIG. 5A) and one or more indexing cavities 130 circumferentially spaced along the first axially inner end surface 124 of the damping ring member 110. Each of the one or more indexing cavities 130 include a cutout portion 132 that extends partially through the main body 112 from the radially external surface 122 and terminates within the main body 112 of the damping ring member 110. The cutout portions 132 may include an axial width w_{IC} (as measured from the first axially inner end surface 124 and extending axially outward towards the second axially outer end surface 128) and a radial thickness t_{IC} (as measured from the first radially inner constant-diameter section 116 and extending radially outward towards the third radially outer constant-diameter section 126). As shown in FIG. 4, the cutout portions 132 may be sized such that the indexing cavities 130 are capable of receiving both an axial width and a radial thickness of a head of a bolt 55 that is used to secure the sprocket gear ring segment 52 to the sprocket drum 56. Additionally, the cutout portions 132 are arranged along the arc length l_{DM} of the first axially inner end surface 124 in a spaced configuration, such that one indexing cavity 130 may receive a single bolt head 55, thereby assisting in restricting rotation of the damping ring members 110. For example, in FIG. 5A, the axial width w_{IC} and the radial thickness t_{IC} of the indexing cavities 130 may be sized to retain a single bolt head 55; however, indexing cavities may be sized to retain more than one bolt head 55.

As noted above, the sprocket damping assembly 100 includes a member retention system that comprises the retention device 160 and the plurality of retaining brackets 170 (shown in FIGS. 3, 4, and 5C). The retention device 160 provides compression to assist in restricting axial, radial, and rotational movement of the damping ring members 110 about the sprocket drum 56 when the retention device 160 is installed into the retention groove 140 (shown in FIGS. 3 and 4). The retention device 160 may take the form of a band clamp, utilizing either a single or multiple clamp sections, with a tension adjusting mechanism (not shown). The retention device 160 may be made from one or more thin strips of steel, other metals or other appropriate materials that may be flexible enough to conform to the external surface 122 of the damping ring members 110 within the retention groove 140, while simultaneously being resistant to stretching.

Additionally, as shown in FIGS. 3, 4, and 5C, the plurality of damping ring members 110 utilize retaining brackets 170, such as a two-hole “Z” type bracket, to connect to the sprocket drum 56 (via an individual threaded drum recess 68) at a first end 171 of the retaining bracket 170 and to the damping ring member 110 at a second end 179 of the bracket. The retaining brackets 170 include a radially inner leg 172, a radially outer leg 178, and a joining central portion 176. Shown in FIGS. 4 and 5C, the radially inner leg 172 and the radially outer leg 178 are substantially parallel, while the joining central portion 176 of the retaining bracket 170 is substantially perpendicular to both the radially inner leg 172 and the radially outer leg 178. The second axially outer end face 128 of an individual damping ring member 110 is offset, both axially and radially, from the sprocket drum end cap 72 in an axially inward and radially outward direction from the sprocket drum cap 72. As such, when the damping assembly 100 is assembled on the drive sprocket 50, the first end 171 of the individual bracket 170 is axially and radially distanced from the second end 179 of the bracket 170, with the joining central portion 176 connecting or spanning the distance between the two structures.

Referring back to FIG. 4, the sprocket drum 56 includes a plurality of threaded drum recesses or blind holes 68 (one of which is shown in FIG. 4) that are circumferentially spaced along an axially outer end face 66 of the drum 56. The end cap 72, which includes a plurality of endcap through holes 74 (one of which is shown in FIG. 4), is mechanically fastened to the sprocket drum 56 along the axially outer end face 66 by inserting a plurality of threaded drum bolts 70 through an endcap through hole 74 and into an individual threaded drum recess 68. As best shown in FIGS. 4 and 5C, the first end 171 of the radially inner leg 172 includes a circular through hole 174, through which the individual threaded bolt 70 is inserted to attach the radially inner leg 172 to the endcap 72.

In FIG. 5B, the second axially outer end face 128 of the damping ring members 110 includes a plurality of connection recesses 134 that extend in an axially inward direction from the end face 128. Each connection recess 134 receives a corresponding threaded insert 136, which may be attached during the molding process (e.g., overmolding) to maintain the integrity of the damping ring member 110 material or may be mechanically attached via insertion. Each threaded insert 136 includes an external profile 137 that securely fastens the individual insert 136 within an individual connection recess 134 of the damping ring member 110 and an internal threaded profile 139 that corresponds to a bracket fastener 138 (e.g. a threaded bolt) for attaching the second end 179 of the radially outer leg 178, through a substantially ovular or slot-shaped through hole 180, to the damping ring members 110. The retaining bracket 170 is securely attached to the sprocket drum 56 (via the threaded drum fastener 70) and to the damping ring member 110 (via the threaded bracket fastener 138), as depicted in FIG. 4. Alternatively, the retaining bracket 170 may include a plurality of washers (not shown), to be used in combination with the threaded bracket fasteners 138 and the threaded inserts 136, to fasten the retaining bracket 170 to the damping ring member 110.

### INDUSTRIAL APPLICABILITY

The disclosed aspects of the sprocket damping assembly 100 for the drive sprocket 50 of the present disclosure may be used reduce the amount of noise generated by the metal-to-metal contact of the sprocket teeth 54 coming into contact with the bushings 30 of the track links 22 when the tractor-type industrial machine 10 is operating. Additionally, the sprocket damping assembly 100 may assist in limiting axial and radial movement of a mounted damping ring members 110 during operation of the machine 10.

As shown in FIGS. 1 and 2, the sprocket damping assembly 100 is configured to contact the track links 22 during engagement of the bushings 30 with the sprocket teeth 54. In order to do so, the sprocket damping assembly 100 is installed onto a circumferential surface 58 of the sprocket drum 56. The sprocket damping assembly 100 includes a plurality of damping ring members 110 that are installed onto the circumferential surface 58, such that the circumferential surface 58 of the sprocket drum 56 is completely enveloped. Each damping ring members 110 is installed by aligning a plurality of indexing cavities 130 with a plurality of sprocket gear member bolts 55 that attach segments of a sprocket gear ring 54 to the sprocket drum 56, as shown in FIGS. 3 and 4. The plurality of bolts 55 from the sprocket gear ring segment 52 are placed into cutout portions 132 in a first axially inner end face 124 of the damping ring members 110, thereby securing a first portion of the individual damping ring members 110 and assisting in preventing rotational movement of the damping ring members 110. The individual damping ring members 110 include a plurality of radially inner surfaces 116-120 that conform to the external surfaces 60-64 of the circumferential surface 58 of the sprocket drum 56, as illustrated in FIGS. 3 and 4.

Once the first axially inner end face 124 of the damping ring member 110 has been secured, a plurality of retaining brackets 170 are attached or secured to an end cap 72 of the sprocket drum 56 (via a plurality of threaded drum recesses 68) in an axially outer end face 66 of the sprocket drum 56. The plurality of retaining brackets 170 each include a radially inner leg 172 with a circular through hole 174 (shown in FIGS. 3, 4, and 5C). Individual threaded drum fasteners 70 are inserted through the circular through hole 174 of the retaining bracket 170, through an end cap through hole 74, and into an individual threaded drum recess 68, thereby securing the radially inner leg 172 of the retaining bracket 170 to the drive sprocket 50. A radially outer leg 178 of the retaining bracket 170, which includes a substantially ovular or slot-shaped through hole 180, is used to connect the retaining bracket 170 to the damping ring member 110. Specifically, an individual threaded bracket fastener 138 (e.g. a threaded bolt) is inserted through the ovular or slot-shaped through hole 180 and into an internal threaded profile 139 of a threaded bracket insert 136 that has installed into a bracket connection recess 134 on the second axially outer end face 128. The ovular through hole 180 is configured to allow for the adjustment of the retaining bracket 170 during attachment to the damping ring member 110 when the retaining bracket 170 is securely attached to the sprocket drum 56. As shown in FIG. 5B, an exemplary damping ring member 110 is shown to include four threaded bracket inserts 136 per member 110; however, the number of threaded bracket inserts 136 installed onto the damping ring member 110 may vary depending upon the needs of the user. The installation of the damping ring members 110 is repeated until the damping ring members 110 form an annular shape and the circumferential surface 58 of the sprocket drum 56 is fully encapsulated, as shown in exemplary FIG. 2. It should be noted, however, that the user may instead choose to strategically space the damping ring members 110 apart from one another in order to develop zones of protection, as also contemplated by the inventor.

Once the plurality of damping ring members 110 has been installed or circumferentially coupled onto the circumferential surface 58 of the sprocket drum 56, a retention device 160 is installed into the retention groove 140, as shown in FIG. 4. The retention device 160 may provide additional support to the sprocket damping assembly 100 by securing a portion of the damping ring members 110 at another point along their length.

While the installation of the sprocket damping assembly 100 is shown to be on an axially outer side of the drive sprocket 50 as shown in exemplary FIGS. 2 and 3, the sprocket damping assembly 100 may be installed on either side of the sprocket gear ring 54 depending on the configuration of a particular drive sprocket 50 on which the sprocket damping assembly 100 is implemented. Furthermore, those skilled in the art would understand that similar sprocket damping assemblies 100 may be installed on other sprocket wheels supporting the ground-engaging track 20, such as the idler gears, rollers and the like.

In accordance with the present disclosure, the sprocket damping assembly 100 may assist in reducing noise generated by the metal-to-metal contact of the sprocket teeth 54 and the ground-engaging track 20 during operation. Additionally, by securing the damping ring members 110 at both a first axially inner end face 124 (via the drive sprocket bolts 55) and a second axially outer end face 128 (via the retention or “Z” brackets 170), the sprocket damping assembly 100 of the present disclosure helps to ensure that the assembly 100 will contact the track 20 and reduce any potential axial, radial, or rotational movement of the damping rings 110. The sprocket damping assembly 100 is therefore able to incorporate a simple design that utilizes the existing fasteners (e.g., drive sprocket bolts 55 and threaded drum fasteners 70) of the drive sprocket 50 for additional efficiency. Finally, the inclusion of the damping ring members 110 for contacting the track 20 prior to the sprocket teeth 54 may assist in the reduction of forces imparted onto the sprocket teeth 54, thereby decreasing the amount of wear and strain on the sprocket teeth and potentially resulting in improved maintenance costs.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A damping ring assembly for a drive sprocket of a mobile industrial machine, the damping member comprising:
a plurality of damping members, each of the damping members including an arc length, a radial thickness, a plurality of recesses located on an end surface and a retention groove on an outer surface of the damping members; and
a plurality of brackets, the plurality of brackets each including a radially inner leg, a radially outer leg, and a joining central portion that connects the radially inner leg and the radially outer leg.

2. The damping ring assembly of claim 1, wherein the plurality of brackets are configured to be coupled to an end face of the drive sprocket at the radially inner leg and to one of the plurality of recesses in the end surface of an individual damping member at the radially outer leg.

3. The damping ring assembly of claim 2, wherein the radially inner leg and the radially outer leg extend substantially parallel to each other.

4. The damping ring assembly of claim 3, wherein the joining central portion is substantially perpendicular to both the radially inner leg and the radially outer leg.

5. The damping ring assembly of claim 4, wherein the radially inner leg includes a circular through hole configured to connect the radially inner leg to the end face of the sprocket drum via a mechanical fastener.

6. The damping ring assembly of claim 5, wherein the radially outer leg includes a through hole configured to connect the radially outer leg to a recess of the plurality of recesses of the individual damping member via a threaded mechanical fastener.

7. The damping ring assembly of claim 1, wherein the retention groove includes an annular groove width that is less than a width of an individual damping member.

8. The damping ring assembly of claim 1, wherein each damping member includes an internal surface having a first substantially constant-diameter section, a substantially tapered section, and a second substantially constant-diameter section.

9. The damping ring assembly of claim 1, wherein each of the plurality of recesses includes a threaded insert configured to receive a threaded fastener and to secure the individual damping member to a sprocket drum.

10. A drive sprocket damping assembly for a mobile industrial machine, the drive sprocket damping assembly comprising:
a plurality of damping members, each of the damping members including an arc length, a radial thickness, and a plurality of recesses spaced along an end surface, wherein each of the plurality of recesses includes a threaded insert configured to receive a threaded fastener for securing individual damping member to a sprocket drum; and
a plurality of brackets configured to be coupled to an end face of the sprocket drum at a first bracket end and to one of the threaded inserts in the end surface of the individual damping member at a second bracket end,
wherein the plurality of damping members together form a circumferential shape when installed onto a surface of a drive sprocket.

11. The damping ring assembly of claim 10, wherein each of the plurality of brackets include a radially inner leg, a radially outer leg, and a joining central portion that connects the radially inner leg and the radially outer leg.

12. The damping ring assembly of claim 11, wherein the radially inner leg and the radially outer leg are substantially parallel to each other, and wherein the radially inner leg and the joining central portion are substantially perpendicular.

13. The damping ring assembly of claim 11, wherein the radially inner leg includes a circular through hole configured to connect the radially inner leg to the end face of the sprocket drum via a mechanical fastener.

14. The damping ring assembly of claim 11, wherein the radially inner leg includes an ovular through hole configured to connect the radially outer leg to the plurality of recesses of the individual damping member via a threaded mechanical fastener.

15. The damping ring assembly of claim 14, wherein the ovular through hole is configured to allow for the adjustment of the individual bracket relative to an individual hole of the individual damping member.

16. The damping ring assembly of claim 10, further including a plurality of cutout portions circumferentially spaced about an opposite end surface of the damping member with respect to the end surface having the plurality of recesses.

17. The damping ring assembly of claim 10, wherein each damping member includes an internal surface including a first substantially constant-diameter section, a substantially tapered section, and a second substantially constant-diameter section.

18. The damping ring assembly of claim 17, wherein the substantially tapered section tapers radially inwardly away from the end surface having the plurality of recesses.

19. The damping ring assembly of claim 18, wherein, in an assembled configured, the first bracket end is located axially and radially distanced from the second bracket end.

20. A method of assembling a damping ring assembly to a drive sprocket, the damping ring assembly including a plurality of damping members, each of the damping members including an arc length, a radial thickness, a plurality of recesses located on an end surface, and a retention groove on an outer surface of the damping members; and a plurality of brackets, the plurality of brackets each including a radially inner leg, a radially outer leg, and a joining central portion that connects the radially inner leg and the radially outer leg, the method comprising:
fastening the radially inner leg of each of the plurality of brackets to the drive sprocket; and
fastening the radially outer leg of each of the plurality of brackets to one of the plurality of recesses located in the end surface of the damping members,
wherein the fastening of the radially inner legs and radially outer legs is repeated until an entire outer circumference of a surface portion of the drive sprocket is covered with a damping member.
